(19) United States
(12) Patent Application Publication
(10) Pub. No.: US 2007/0254671 A1
(43) Pub. Date: Nov. 1, 2007

(54) Radio Access Network System in Mobile Communication System

(75) Inventor: Sheng Liu, Guangdong (CN)

Correspondence Address: BUCHANAN, INGERSOLL & ROONEY PC, POST OFFICE BOX 1404, ALEXANDRIA, VA, 22313-1404, US

(73) Assignee: UTSTARCOM TELECOM CO., LTD., Hangzhou City (CN)

(21) Appl. No.: 11/632,320

(22) PCT Filed: Jul. 13, 2004
(86) PCT No.: PCT/CN04/00799

§ 371 Date: Feb. 21, 2007

(51) Int. Cl. H04Q 7/20

(52) U.S. Cl. 455/446

(57) ABSTRACT

The present invention provides a radio access network system, comprising: a core network CN; a plurality of radio access gateways (RAGs) each performing processing of all the L1/L2/L3 protocols in a radio interface access layer; and a plurality of remote RF units (RRUs); wherein said plurality of RAGs are connected with said CN via Iu interfaces and are connected with each other via Iur or Iur+ interfaces, said plurality of RAGs are connected with corresponding RRUs via Iua interfaces for realizing the control of said plurality of RAGs over said corresponding RRUs and digital radio signal transmission therebetween. In a specific mode for carrying out the present invention, each of said RAGs is divided into two independent network elements, i.e., a radio bearer server RBS and a radio control server RCS. The above radio access network architecture set forth in the present invention overcomes the problems existing in the original UTRAN architecture, solves the frequent mobility management problem, and supports an architecture which has a clear configuration and an explicit function division and in which the user plane and the control plane of an RAN are separated.

### FIELD OF TECHNOLOGY

The present invention relates in general to the relevant technical field of radio access network in a mobile communications system, and particularly to a novel radio access network system configuration.

### BACKGROUND ART

In the mobile communications system, a radio access network (RAN) usually performs protocol processing associated with an access layer in radio interface protocols, so as to provide required radio bearer services to a higher layer protocol. Taking a universal mobile communications system (UMTS) as an example, the current R99/R4/R5 all adopt the RAN architecture shown in FIG. 1. The RAN architecture comprises two types of network elements: a radio network controller (RNC) and a NodeB, wherein a RNC 2 is connected with one or more NodeBs 3 via Iub interfaces, different RNCs 2 are interconnected via Iur interfaces, and the RNC 2 is connected with a core network (CN) 1 via an Iu interface. The RNC 2 usually performs protocol processings including a packet data convergence protocol (PDCP), a radio link control (RLC), and a media access control (MAC) and the like in radio interface (Uu interface) protocols, while the NodeB 3 is responsible for performing physical layer (PHY) processing in the radio interface protocols.

The UMTS radio interface access layer shown in FIG. 2 consists of a control plane and a user plane, wherein PHY, MAC and RLC layer protocols in the control plane are consistent with those in the user plane. In the control plane, a radio resource control (RRC) layer configures corresponding protocol entities via control interfaces between the RRC layer and other protocol layers in the radio interface access layer, and the protocol entities comprising parameters of physical channels, transport channels and logic channels, while an RRC layer message is also transmitted by the RLC/MAC/PHY via the radio interface. In the user plane, besides the MAC layer and the RLC layer, a packet data convergence protocol (PDCP) layer and a broadcast/multicast control (BMC) layer are further comprised. For details of the above-mentioned UMTS radio interface access layer protocols, refer to TS25.2xx and TS25.3xx serial protocol documents of the 3GPP (the 3^{rd} Generation Partnership Project).

The Iu, Iur and Iub interface protocols in the UMTS radio access network (UTRAN) shown in FIG. 1 are also divided into a control plane and a user plane in a vertical direction, wherein radio network layer (RNL) user plane protocols of Iu and Iur/Iub interfaces are an Iu-UP protocol and an FP data frame protocol, respectively, and RNL control plane protocols of Iu, Iur and Iub interfaces are RANAP (Radio Access Network Application Part), RNSAP (Radio Network Sub-system Application Part), and NBAP (NodeB Application Part), respectively. For details of the above-mentioned UTRAN interface protocols, refer to TS 25.4xx serial protocol documents of the 3GPP.

However, with the evolution of the UMTS technology, the problems of the current UTRAN system architecture gradually become prominent as well. As reported in the 3GPP technical report TR25.897, since the upper layer protocol entities of the radio interface access layer are in the RNC, FP frames of the Iub interface will cause a stipulated transmission time delay, and it is hard for the RLC to perform a quick and effective ARQ (Automatic Repeat Request) retransmission operation and large time delay also exerts bad influence on an outer-loop power control. Thus, the 3GPP established a research project (SI) on “Evolution of UTRAN Architecture” at the TSG RAN#17 conference, in which two new radio access network system architectures as shown in FIG. 3 and FIG. 4 are mainly proposed in the technical report “TR25.897, Feasibility Study on the Evolution of UTRAN Architecture, V0.3.1, August, 2003” of the SI.

The radio access network shown in FIG. 3 consists of radio network gateways (RNG) 4 and NodeB+s 5. Actually the NodeB+s 5 are formed by combining the NodeBs and RNCs in the original UTRAN architecture shown in FIG. 1, so Iub interfaces are no longer needed; the mobility management function is realized by Iur interfaces between neighboring NodeB+s. The RNG 4 has a function of a converging interface between the RAN and the CN 1 on one hand, and is also responsible for inter-operation with the current UTRAN on the other hand. Thus, the RNGs 4 and the NodeB+s 5 also have partial functions of the Iu and Iur interfaces.

The radio access network architecture shown in FIG. 3, by combining functions of the NodeBs 3 and the RNCs 2 in the original UTRAN architecture, causes processing of all the L1/L2/L3 protocols in the radio interface access layer to be performed within a single network node, so that the problem caused by time delay in the above original UTRAN architecture is overcome. However, a new problem is introduced: in this architecture, there are complicated interfaces between the RNGs 4 and the NodeB+s 5 and the interface protocol functions and structures in the original UTRAN architecture are greatly changed, which is not helpful for re-utilize the original UTRAN interface protocols to the maximum extent. In addition, in this architecture, the NodeB+s 5, alike as the NodeBs 3 in the original UTRAN architecture shown in FIG. 1, can only control a small number of cells. Thus, the NodeB+s have a rather large number and are scattered in geographical distribution, and additionally, the Iur interfaces exist between the NodeB+s 5, so the planning and building of the RAN transmission network are made rather complicated. Moreover, the small-scaled and great-numbered distributed architecture of the NodeB+s 5 hugely increases frequencies of mobility management including NodeB+ displacement within the RAN and the like, and this causes system complexity and stability problems and ultimately affects the quality of service of users. Meanwhile, since the development of mobile communication gradually tends toward adopting the micro-cell technology, the above problem becomes more prominent.

Another radio access network shown in FIG. 4 adopts the architecture in which the user plane and the control plane of the RNC 2 in the original UTRAN architecture shown in FIG. 1 are separated, that is, the functions of the NodeBs 3 are maintained, while each RNC 2 is divided into two independent network elements, i.e., a user plane server (UPS) 2-2 and a radio control server (RCS) 2-1. The UPS 2-2 is responsible for protocol processing of the radio interface access layer other than the RRC, while the RCS 2-1 performs the RRC protocol processing and controls the UPSs 2-2 and the NodeBs 3. As shown in FIG. 4, an Iu-c interface exists between the RCS 2-1 and the CN 1, Iu-u interfaces exist between the UPSs 2-2 and the CN 1, an Iur-c interfaces exists between the RCS 2-1 and the RCS 2-1, and an Iur-u interface exists between the UPS 2-2 and the UPS 2-2, and the above interfaces substantially can continue to utilize control plane and user control protocols of the Iu and Iur interfaces in the original UTRAN architecture, but it is necessary to re-define interfaces between the RCS 2-1 and the UPSs 2-2, i.e., Iui interfaces.

The radio access network architecture shown in FIG. 4, by separating the user plane and the control plane of the RNC in the original UTRAN architecture, causes the system to have a good scalability, that is, it is possible to reasonably configure the scales of the RCS 2-1 and UPS 2-2 based on the requirements of the operated services on the control plane processing capability and user plane processing capability, respectively. However, this architecture does not solve the foregoing problems existing in the original UTRAN architecture. Furthermore, since the NodeBs 3 are merely connected to the UPS 2-2, a control signalling NBAP for the NodeBs 3 is either terminated by the UPS 2-2 or transferred by the UPS 2-2, but whichever mode is utilized, the principles of the UPS 2-2 for the user plane processing will be affected.

### SUMMARY OF THE INVENTION

The present invention, in view of the deficiencies of the above radio access network system architecture in the prior art, provides a new radio access network architecture and system, which not only overcomes the problems existing in the original UTRAN architecture and solves the frequent mobility management problem, but also supports an architecture which has a clear configuration and an explicit function division and in which the user plane and the control plane of an RAN are separated, and easily achieves the smooth evolution from the existing R99/R4/R5 UTRAN architecture.

According to the present invention, a radio access network system is provided, the radio access network system comprising:

a core network CN;

a plurality of radio access gateways (RAGs) each performing processing of all the L1/L2/L3 protocols in a radio interface access layer; and

a plurality of remote RF units (RRUs);

wherein said plurality of RAGs are connected with said CN via Iu interfaces and are connected with each other via Iur or Iur+ interfaces, and said plurality of RAGs are connected with corresponding RRUs via Iua interfaces for realizing the control of said plurality of RAGs over said corresponding RRUs and digital radio signal transmission therebetween.

In a specific mode for carrying out the present invention, each of said RAGs is divided into two independent network elements, i.e., a radio bearer server RBS and a radio control server RCS. The respective RCSs and the CN are connected via Iu-c interfaces, the respective RBSs and the CN are connected via Iu-u interfaces, the respective RCSs are connected with each other via Iur-c or Iur-c+ interfaces, the respective RBSs are connected with each other via Iur-u or Iur-u+ interfaces, and the respective RCSs and the corresponding RBSs are connected via Iui interfaces for realizing the control of said RCSs over the corresponding RBSs, wherein said Iu-c interfaces, Iu-u interfaces, Iur-c or Iur-c+ interfaces, and Iur-u or Iur-u+ interfaces utilize control plane and user plane protocols corresponding to said Iu and Iur/Iur+ interfaces, respectively.

The above-described radio access network architecture provided by the present invention overcomes the problems existing in the original UTRAN architecture, solves the frequent mobility management problem, and supports an architecture which has a clear configuration and an explicit function division and in which the user plane and the control plane of an RAN are separated.

### BRIEF DESCRIPTION OF THE ACCOMPANYING DRAWINGS

The specific modes for carrying out the invention are described below in detail with reference to the accompanying drawings. In the accompanying drawings, one identical reference sign represents the same or similar composite units, wherein

FIG. 1 shows an RAN architecture utilized in the current R99/R4/R5;

FIG. 2 shows a UMTS radio interface access layer protocol architecture;

FIG. 3 shows a radio access network system architecture set forth in the 3GPP TR25.897;

FIG. 4 shows another radio access network system architecture set forth in the 3GPP TR25.897;

FIG. 5 is a view showing one mode for carrying out the radio access network system architecture according to the present invention;

FIG. 6 is a view showing another mode for carrying out the, radio access network system architecture according to the present invention; and

FIG. 7 is a structural view showing a radio access gateway (RAG) utilized in the radio access network system architecture according to the present invention.

### BEST MODES FOR CARRYING OUT THE INVENTION

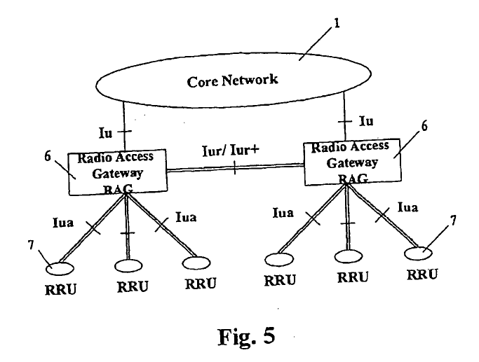

FIG. 5 is a view showing one mode for carrying out the radio access network system architecture according to the present invention. As shown in FIG. 5, a radio access network consists of radio access gateways (RAGs) 6 and remote RF units (RRUs) 7, the RAGs 6 are connected with the CN 1 via Iu interfaces, the RAGs 6 are connected with each other via Iur or Iur+ interfaces, and the RAGs 6 are connected with the corresponding RRUs 7 via Iua interfaces, for realizing the control of said plurality of RAGs over corresponding RRUs and digital radio signal transmission therebetween.

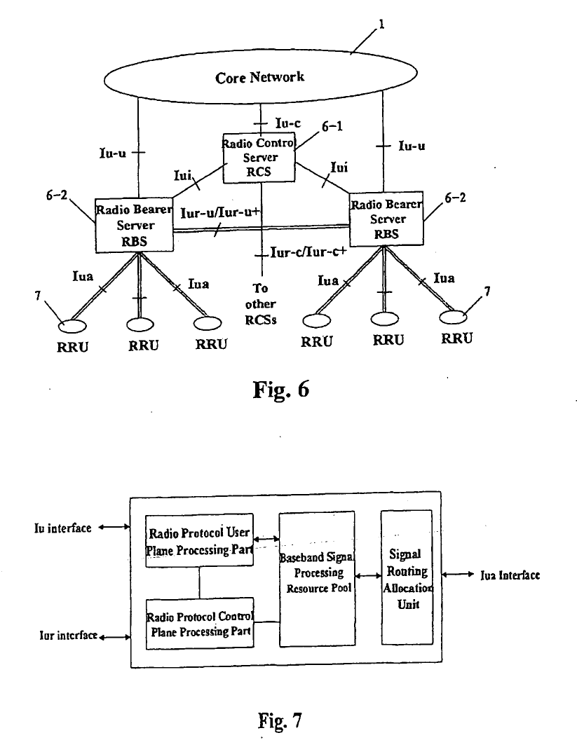

FIG. 7 is a structural view showing the radio access gateway (RAG) 6 utilized in the radio access network system architecture according to the present invention. As shown in FIG. 7, the RAG 6 is mainly composed of a signal routing allocation unit, a baseband signal processing resource pool, a radio protocol user plane processing part and a radio protocol control plane processing part, etc., wherein the baseband signal processing resource pool consists of a plurality of baseband signal processing units for performing baseband signal processing of a physical layer in radio interfaces, and the radio protocol user plane processing part and the radio protocol control plane processing part perform processing of a user plane and a control plane of the radio interfaces (other than the physical layer) and the RAN interfaces, respectively. Taking the UMTS system as an example, the radio protocol user plane processing part comprises MAC, RLCP, DCP, BMC, Iu-UP and FP data frame protocol of the Iur interface, etc., the radio protocol control plane processing parts comprises RRC, RANAP and RNSAP, etc., and the signal routing allocation unit dynamically allocates channel processing resources based on traffic differences of respective cells, so as to realize effective sharing of multi-cell processing resources. The RRU corresponds to an RF part of a base station in the prior-art RAN architecture and mainly consists of a transmit channel RF power amplifier, a receive channel low noise amplifier, a duplexer, antennas and other functionality units.

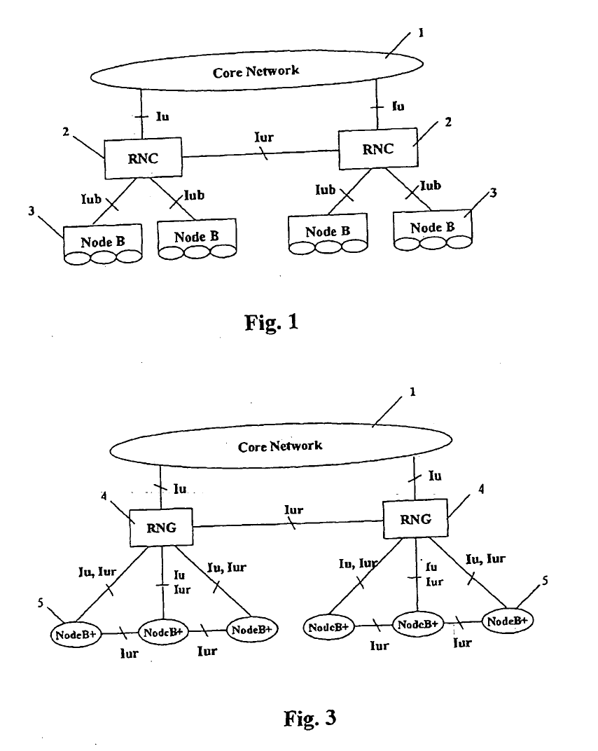

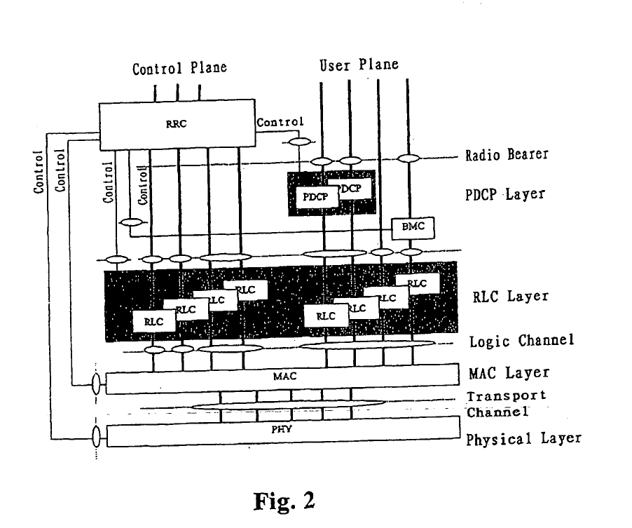

It can be seen that, the RAG 6 actually performs functions of the NodeBs 3 and the RNC 2 in the RAN architecture shown in FIG. 1, so that the processing of all the L1/L2/L3 protocols of the radio interface access layer is performed within a single network node. However, in contrast with the RAN architecture shown in FIG. 3, since the RF part in the base station is taken apart to form the independent RRU 7, and the RAG 6 utilizes a large-capacitance and scalable baseband signal processing resource pool, so that one RAG is allowed to control a large-scaled RRU, while the RRU performs a geographically large-scaled distribution of the cells. On the contrary, in the RAN architecture shown in FIG. 3, since the antennas must be mounted at different stations to form the required cell coverage, the RF part contained actually limits the scale of the NodeB+s. Thus, in the present invention, the RAG 6 is allowed to control a quite large number of cells so as to avoid frequent displacement of the RAG 6 due to UE movement. Therefore, the present invention, while overcoming many potential problems caused by time delay resulting from the separation of the NodeBs 3 and the RNCs 2 in the original UTRAN architecture shown in FIG. 1, effectively avoids the frequent mobility management problem.

The RAG 6 is capable of controlling a quite large number of cells and thus corresponds to the combination of the RNC 2 and a plurality of NodeBs 3 (excluding the RF units) under its control in the original UTRAN architecture, so the Iub interfaces are no longer needed and the Iu and Iur interfaces in the R99/R4/R5 UTRAN architecture can entirely continue to be utilized. In addition, the interfaces between the RAGs 6 can further be Iur+ interfaces which further provide an RAG baseband signal processing load sharing function on the basis of the Iur interfaces, wherein said baseband signal processing load sharing function means that when the occupancy of a baseband signal processing resource pool of a certain RAG achieves a stipulated upper limit, digital radio signals corresponding to some cells having higher traffic are exchanged to other RAGs via the Iur+ interfaces, and said other RAGs perform baseband signal processing and radio protocol processing of the corresponding cells, thereby realizing the purpose of load sharing between the RAGs.

The Iua interfaces between the RAGs 6 and the RRUs 7 are mainly responsible for transmitting digital radio signals and relevant control information, wherein the digital radio signals typically are digital I/Q (In-phase component/Quadrature component) baseband signals. Regarding the technology of transmitting the digital radio signals and relevant control information in the interface, the solutions proposed in two applications for a patent filed by the same applicant as that of the present invention on Jul. 12, 2004 can be preferably adopted, which two applications are titled “Packet Transmission Method for Radio Signals in Radio Base Station System” and “Method for Interfacing between Remote RF Unit and Centralized Base Station”, respectively. Certainly, those skilled in the art understand that other known techniques of transmitting digital radio signals and relevant control information in the Iua interface can also be adopted. Meanwhile, the transmission of the digital radio signals in the aforesaid Iur+ interface can also utilize the same technique as that for the Iua interface.

FIG. 6 is a view showing another mode for carrying out the radio access network system architecture according to the present invention. Concretely speaking, FIG. 6 shows the further evolution of the radio access network shown in FIG. 5 to an architecture in which the user plane and the control plane of an RAG 6 are separated, that is, the RAG 6 is divided into two independent network elements, i.e., a radio bearer server (RBS) 6-2 and a radio control server (RCS) 6-1. The interface between the RCS 6-1 and the CN 1 is Iu-c, the interfaces between the RBS 6-2 and the CN 1 are Iu-us, the interface between the RCSs 6-1 is Iur-c or Iur-c+, the interface between the RBSs 6-2 is Iur-u or Iur-u+, and the RCS 6-1 and the RBSs 6-2 are connected via the Iui interfaces for realizing the control of said RCS over the corresponding RBSs. Except that the Iui interfaces need to be re-defined, other interfaces substantially can continue to utilize control plane and user plane protocols of the Iu and Iur/Iur+ interfaces in the RAN shown in FIG. 5. As for the re-definition of the Iui interfaces, those skilled in the art may make the re-definition based on the foregoing functions and control relations between the RCS 6-1 and the RBSs 6-2 according to practical conditions, and since the details of this re-definition is not critical for the present invention, it is not explained in detail here.

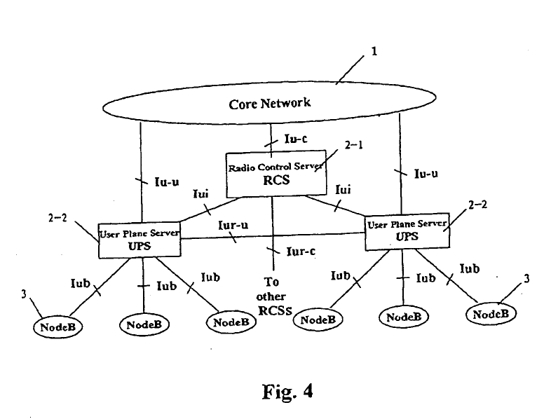

In the RAN shown in FIG. 6, the RBS 6-2 mainly comprises the signal routing allocation unit, the baseband signal processing resource pool, the radio protocol user plane processing part and other functionality units as in the RAG 6 in the RAN shown in FIG. 5, and is responsible for processing radio interface access layer protocols other than the RRC; the RCS 6-1 mainly comprises the radio protocol control plane processing part in the RAG 6 and is responsible for performing the RRC protocol processing and the control over the RBSs 6-2. Compared with the RAN architecture shown in FIG. 4, the RAN shown in FIG. 6 performs processing of L1/L2 protocols of the radio interface access layer within a single network node RBS 6-2, so that the foregoing potential problems caused by time delay resulting from the separation of the NodeBs 3 and the RNCs 2 in the original UTRAN architecture shown in FIG. 1 are overcome. Meanwhile, the RCS 6-1 only controls the RBS 6-2 and thus avoids the problems caused by the case in which the control signalling for the NodeBs 3 needs to be terminated or transferred by the UPS 2-2 in the RAN architecture shown in FIG. 4. Thus, an architecture which has a clear configuration and an explicit function division and in which the user plane and the control plane of the RAN are separated is produced.

In fact, according to the above analysis, the RAN architectures shown in FIG. 5 and FIG. 6 as set forth by the present invention, besides having overcome the deficiencies of the prior-art RAN architecture, namely, having overcome the problems existing in the original UTRAN architecture, solving the frequent mobility management problem and supporting the architecture which has a clear configuration and an explicit function division and in which the user plane and the control plane of the RAN are separated, further has the following distinct advantages:
A centralized baseband signal processing resource pool architecture is allowed to utilize an effective dynamic resource scheduling mechanism, so that the expensive baseband signal processing resources are shared by all the cells of the RAG or RBS/RCS; thus, compared with the prior-art RAN technology, the number of the required baseband signal processing resources is obviously reduced and system costs are effectively decreased.
The centralized baseband signal processing resource pool architecture is capable of auto-adapting itself to dynamic traffic variance in the respective cells of the RAG or RBS/RCS and realizes a dynamic load sharing among the cells; compared with the prior-art RAN technology, it can effectively decrease call losses caused by a short-term traffic peak occurring in a certain cell, so as to improve the quality of service for users.
The centralized baseband signal processing resource pool architecture enables a soft handover of a Code Division Multiple Access (CDMA) system in the traditional RAN to be performed by a softer handover, so as to obtain extra process gains and improve radio performances.
Since the RRU mainly comprises an RF part, compared with the NodeB or NodeB+ in the prior-art RAN technology, effectively reduces requirements in terms of volume, power consumption, power supply and working environment, etc., and thus it facilitates engineering installation, operation maintenance and station selection.

For the sake of convenient explanations, the above modes for carrying out the present invention are described taking the UTRAN in the UMTS as an example. However, the RAN architecture and system set forth in the present invention are not limited by specific radio access techniques, and is thus adapted to a mobile communications system using any access technique, such as CDMA2000, GSM/GPRS, UTRA TDD, TD-SCDMA, and other prior-art or future communications systems.

The present invention has been specifically described above with reference to specific implementing modes, but under the teaching of the above-disclosed technical contents, those skilled in the art can conceive further improvements or modifications to the above specific implementing solutions. These improvements or modifications shall be considered to fall within the scope defined by the enclosed claims.

1. A radio access network system, comprising:
a core network CN;
a plurality of radio access gateways (RAGs) each performing processing of all the L1/L2/L3 protocols in a radio interface access layer; and
a plurality of remote RF units (RRUs);
wherein said plurality of RAGs are connected with said CN via Iu interfaces and are connected with each other via Iur or Iur+ interfaces, and said plurality of RAGs are connected with corresponding RRUs via Iua interfaces for realizing the control of said plurality of RAGs over said corresponding RRUs and digital radio signal transmission therebetween.

2. The radio access network system according to claim 1, wherein each of said RAGs performs functions of NodeBs and a radio network controller RNC in a radio access network RAN architecture, and each of said RAGs comprises:
a signal routing allocation unit for dynamically allocating channel processing resources based on traffic differences of respective cells, so as to realize effective sharing of multi-cell processing resources;
a baseband signal processing resource pool which consists of a plurality of baseband signal processing units for performing baseband signal processing of a physical layer in radio interfaces; and
a radio protocol user plane processing part and a radio protocol control plane processing part for performing processing of a user plane and a control plane of the radio interfaces (other than the physical layer) and RAN interfaces.

3. The radio access network system according to claim 2, wherein said radio access network system is a UMTS system, said radio protocol user plane processing part comprises MAC, RLCP, DCP, BMC, Iu-UP and FP data frame protocols of the Iur interface, said radio protocol control plane processing part comprises RRC, RANAP and RNSAP, and each of said RRUs comprises a transmit channel RF power amplifier, a receive channel low noise amplifier, a duplexer and antennas.

4. The radio access network system according to claim 1, wherein when said RAGs are connected with each other via the Iur+ interfaces, said Iur+ interfaces are configured to exchange, when the occupancy of a baseband signal processing resource pool of a certain RAG achieves a stipulated upper limit, digital radio signals corresponding to some cells having higher traffic to other RAGs via corresponding Iur+ interfaces, and said other RAGs perform baseband signal processing and radio protocol processing of corresponding cells, thereby realizing load sharing between the RAGs.

5. The radio access network system according to claim 1, wherein the Iua interfaces between said RAGs and corresponding RRUs are for transmitting digital radio signals and relevant control information, wherein said digital radio signals are digital in-phase component/quadrature component I/Q baseband signals, and the transmission of digital radio signals in said Iur+ interfaces utilizes the same technique as that in said Iua interfaces.

6. The radio access network system according to claim 1, wherein each of said RAGs is divided into two independent network elements, i.e., a radio bearer server RBS and a radio control server RCS, the respective RCSs and the CN are connected via Iu-c interfaces, the respective RBSs and the CN are connected via Iu-u interfaces, the respective RCSs are connected with each other via Iur-c or Iur-c+ interfaces, the respective RBSs are connected with each other via Iur-u or Iur-u+ interfaces, and the respective RCSs and the corresponding RBSs are connected via Iui interfaces for realizing the control of said RCSs over the corresponding RBSs, wherein said Iu-c interfaces, Iu-u interfaces, Iur-c or Iur-c+ interfaces, and Iur-u or Iur-u+ interfaces utilize control plane and user plane protocols corresponding to said Iu and Iur/Iur+ interfaces, respectively.

7. The radio access network system according to claim 6, wherein said RBS comprises said signal routing allocation unit, baseband signal processing resource pool, and radio protocol user plane processing part in said RAG for processing radio interface access layer protocols other than the RRC, and wherein, said RCS comprises said radio protocol control plane processing part in said RAG for performing the RRC protocol processing and the control over corresponding RBSs.

8. The radio access network system according to claim 2, wherein when said RAGs are connected with each other via the Iur+ interfaces, said Iur+ interfaces are configured to exchange, when the occupancy of a baseband signal processing resource pool of a certain RAG achieves a stipulated upper limit, digital radio signals corresponding to some cells having higher traffic to other RAGs via corresponding Iur+ interfaces, and said other RAGs perform baseband signal processing and radio protocol processing of corresponding cells, thereby realizing load sharing between the RAGs.

9. The radio access network system according to claim 3, wherein when said RAGs are connected with each other via the Iur+ interfaces, said Iur+ interfaces are configured to exchange, when the occupancy of a baseband signal processing resource pool of a certain RAG achieves a stipulated upper limit, digital radio signals corresponding to some cells having higher traffic to other RAGs via corresponding Iur+ interfaces, and said other RAGs perform baseband signal processing and radio protocol processing of corresponding cells, thereby realizing load sharing between the RAGs.

10. The radio access network system according to claim 2, wherein the Iua interfaces between said RAGs and corresponding RRUs are for transmitting digital radio signals and relevant control information, wherein said digital radio signals are digital in-phase component/quadrature component I/Q baseband signals, and the transmission of digital radio signals in said Iur+ interfaces utilizes the same technique as that in said Iua interfaces.

11. The radio access network system according to claim 3, wherein the Iua interfaces between said RAGs and corresponding RRUs are for transmitting digital radio signals and relevant control information, wherein said digital radio signals are digital in-phase component/quadrature component I/Q baseband signals, and the transmission of digital radio signals in said Iur+ interfaces utilizes the same technique as that in said Iua interfaces.

12. The radio access network system according to claim 4, wherein the Iua interfaces between said RAGs and corresponding RRUs are for transmitting digital radio signals and relevant control information, wherein said digital radio signals are digital in-phase component/quadrature component I/Q baseband signals, and the transmission of digital radio signals in said Iur+ interfaces utilizes the same technique as that in said Iua interfaces.

13. The radio access network system according to claim 2, wherein each of said RAGs is divided into two independent network elements, i.e., a radio bearer server RBS and a radio control server RCS, the respective RCSs and the CN are connected via Iu-c interfaces, the respective RBSs and the CN are connected via Iu-u interfaces, the respective RCSs are connected with each other via Iur-c or Iur-c+ interfaces, the respective RBSs are connected with each other via Iur-u or Iur-u+ interfaces, and the respective RCSs and the corresponding RBSs are connected via Iui interfaces for realizing the control of said RCSs over the corresponding RBSs, wherein said Iu-c interfaces, Iu-u interfaces, Iur-c or Iur-c+ interfaces, and Iur-u or Iur-u+ interfaces utilize control plane and user plane protocols corresponding to said Iu and Iur/Iur+ interfaces, respectively.

14. The radio access network system according to claim 3, wherein each of said RAGs is divided into two independent network elements, i.e., a radio bearer server RBS and a radio control server RCS, the respective RCSs and the CN are connected via Iu-c interfaces, the respective RBSs and the CN are connected via Iu-u interfaces, the respective RCSs are connected with each other via Iur-c or Iur-c+ interfaces, the respective RBSs are connected with each other via Iur-u or Iur-u+ interfaces, and the respective RCSs and the corresponding RBSs are connected via Iui interfaces for realizing the control of said RCSs over the corresponding RBSs, wherein said Iu-c interfaces, Iu-u interfaces, Iur-c or Iur-c+ interfaces, and Iur-u or Iur-u+ interfaces utilize control plane and user plane protocols corresponding to said Iu and Iur/Iur+ interfaces, respectively.
